(19) United States
(12) Patent Application Publication
(10) Pub. No.: US 2025/0272568 A1
(43) Pub. Date: Aug. 28, 2025

(54) SYSTEM AND METHOD FOR DEFINING NEURAL NETWORK CLASSIFIER PERFORMANCE

(71) Applicant: Textron Innovations Inc., Providence, RI (US)

(72) Inventor: Jeffrey W. Holcomb, Fort Worth, TX (US)

(21) Appl. No.: 18/584,331

(22) Filed: Feb. 22, 2024

(51) Int. Cl. G06N 3/092; G06N 3/0464

(52) U.S. Cl. CPC G06N 3/092; G06N 3/0464

(57) ABSTRACT

A method for defining neural network classifier performance includes causing processing of data by a plurality of convolutional layers of an artificial intelligence (AI) agent, where the processing of the data is caused by providing data to the AI agent, receiving one or more outputs from a first convolutional layer of the plurality of convolutional layers, generating one or more classification data points by processing the one or more outputs through a classifier of the NN that classifies the one or more outputs into two or more classifications, determining an interface region between the two or more classifications, determining a percentage of classification data points that fall into the interface region, and providing the AI agent as an AI agent with a verified classifier in response to the percentage of classification data points that fall into the interface region being below a threshold.

### TECHNICAL FIELD

The present invention relates generally to a system and method for providing an artificial intelligence (AI) or machine learning (ML) agent using a neural network (NN) and classifier with verifiable quality, and in particular, to determining the performance of an NN classifier for inclusion in the NN of an AI/ML agent.

### BACKGROUND

The training and certification of industrial grade AI/ML, for aerospace applications in particular, is difficult and expensive. In some cases, the ability of a classifier in the NN of AI or ML agent to correctly classify objects is an important use of the object recognition AI agents. Concerns about AI/ML technologies have led government agencies, such as the European Union Aviation Safety Agency, to add requirements for learning process verification for training AI or ML agents.

AI and ML agents traditionally have difficulty classifying data sets that have overlapping categories of information. Neural networks attempt to classify data by quantifying features in the data. However, where different pieces of data being analyzed are similar in their qualities, proper classification of the data can be difficult. Knowing the achievable efficiency or accuracy of data classification is an important part of neural network certification.

### SUMMARY

An embodiment system includes at least one processor, and at least one first non-transitory computer readable medium having computer program code stored thereon for execution by the at least one processor to evaluate a classifier of a neural network (NN) of an artificial intelligence (AI) agent. The computer program code includes instructions for causing, by providing data to the AI agent, processing of the data by a plurality of convolutional layers in the NN of the AI agent, receiving one or more outputs from a first convolutional layer of the plurality of convolutional layers, generating one or more classification data points by processing the one or more outputs through a classifier that classifies the one or more outputs into two or more classifications, determining an interface region between the two or more classifications, determining a percentage of classification data points that fall into the interface region, and providing the AI agent as an AI agent with a verified classifier in response to the percentage of classification data points that fall into the interface region being below a threshold.

An embodiment method includes causing processing of data by a plurality of convolutional layers in a neural network (NN) of an artificial intelligence (AI) agent, where the processing of the data is caused providing data to the AI agent, receiving one or more outputs from a first convolutional layer of the plurality of convolutional layers, generating one or more classification data points by processing the one or more outputs through a classifier of the NN that classifies the one or more outputs into two or more classifications, determining an interface region between the two or more classifications, determining a percentage of classification data points that fall into the interface region, and providing the AI agent as an AI agent with a verified classifier in response to the percentage of classification data points that fall into the interface region being below a threshold.

An embodiment system includes at least one processing circuit, configured to evaluate a classifier of a neural network (NN) of an artificial intelligence (AI) agent, where the at least one processing circuit is configured to perform receiving one or more classification data points associated with one or more outputs that are processed through a classifier and that are outputs associated with data processing by a first convolutional layer of a plurality of convolutional layers of the NN, where the one or more classification data points are associated with two or more classifications performed by the classifier, determining a separation plane between the two or more classifications, determining support vectors according to the separation plane, where an interface region is defined by the support vectors, determining a percentage of classification data points that fall into the interface region, and providing the AI agent as an AI agent with a verified classifier in response to the percentage of classification data points that fall into the interface region being below a threshold.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A-1B are symbolic diagrams illustrating architectures and training systems for AI agents according to some embodiments;

FIG. 2 is a system diagram illustrating a system for training an AI agent according to some embodiments;

FIGS. 3A-3B are diagrams illustrating classifier outputs according to some embodiments;

FIGS. 4A-4C are diagrams illustrating evaluation of classifier accuracy according to some embodiments; and

FIG. 5 is a flow diagram illustrating a method for evaluating a classifier for inclusion in an AI agent according to some embodiments.

### DETAILED DESCRIPTION OF ILLUSTRATIVE EMBODIMENTS

Representative embodiments of systems and methods of the present disclosure are described below. In the interest of clarity, features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

Data analytics methodologies including artificial intelligence and machine learning have difficulty classifying data sets that have overlapping categories of information. One method that classifiers, such as neural networks, use in attempting to classify data is defining one or more hyperdimensional surfaces of separation between the two, or more, data categories. The amount of overlap tends to indicate the performance of the classifier. A significant degree of overlap between data distributions for two or more categories of data makes proper classification of the data difficult. Optimizing coverage with-respect to data sampling is useful in training AIs, but data space coverage is not the same as developing methodologies for tracking and analyzing the geometry of the data classifier.

The principles presented herein relate to an automated system for evaluating the efficiency or accuracy of a classifier, which may be used at the neuron level, or after training of an AI agent. The efficiency may be determined by identifying classification outputs that fall between identifiable classification parameter groupings. A region between classifications may be delineated by support vectors associated with a boundary or separation plane between classifications, with output values from an AI agent or NN that fall near the separation plane having a higher likelihood of being misclassified than outputs that fall farther from the separation plane. Thus, the systems and methods described herein provide for an automated process for evaluating the accuracy of a neural network layer or classifier, allowing for adjustment of the AI agent prior to the AI agent entering production.

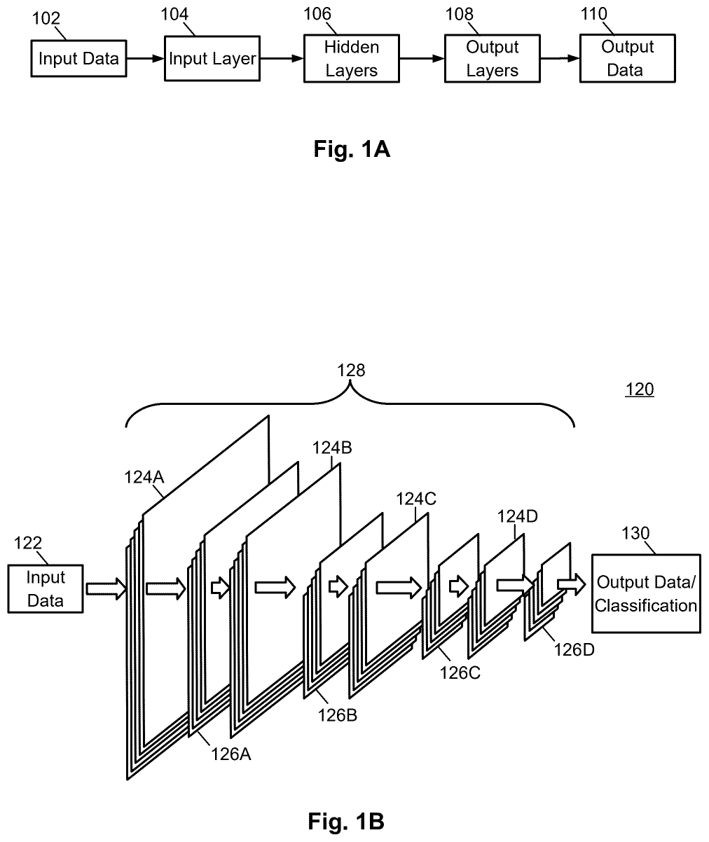

FIGS. 1A-1B are symbolic diagrams illustrating architectures and training systems for AI models according to some embodiments. AI models are a set of mathematical functions that can be used to correlate incoming data with known elements, such as images, sounds, motions, and the like. Thus, an AI model may be a set of functions used for image, sound, text or motion recognition. A commonly used AI recognition model is a CNN. AI agents may be software or other implementations of an AI model.

FIG. 1A is a symbolic diagram illustrating layers of an AI model 100 according to some embodiments. An AI model 100 take in input data 102 though an input layer 104. The input layer 104 converts input data 102 into a format usable by hidden layers 106. For example, in an image recognition or computer vision AI model, the input data 102 may be, for example, an image with two dimensions. In some embodiments, the input layer 104 may convert the image input data 102 into a numeric representation such as a matrix with the data values reflected in the matrix. In other embodiments, the input layer 104 may convert multidimensional input data 102 into a single dimension array, apply filters, trim or normalize input data 102, or perform other pre-processing functions.

The input layer 104 provides the prepared data to a set of hidden layers 106. In a CNN, the hidden layers 106 provide one or more convolutions or filters. The hidden layers 106 may use filters that are trained by applying weights and biases to a variety of filters to identify desired features from the image data. In some embodiments, the hidden layers 106 may provide probabilities or other data related to extracted or identified features. A CNN may take advantage of hierarchical patterns in input data and assemble patterns of increasing complexity using smaller and simpler patterns in the filters of convolutional layers. Thus, CNNs utilize the hierarchical structure of the data they are processing. CNNs break input data down into smaller, simpler features, which are represented by the filters of the convolutional layers. These filters are applied to different regions of the input to extract the relevant information. As the network progresses through the layers, these features are combined and assembled into more complex patterns, allowing the network to learn increasingly abstract representations of the input.

An output layer 108 may be used to classify data received from the hidden layers 106. The output layer 108 uses the output from the hidden layers 106 to determine a probability that a particular image belongs to a particular classification.

FIG. 1B is a symbolic diagram illustrating layers of an CNN AI model 120 according to some embodiments. A CNN AI model 120 may have hidden layers 128 that receive input data 122 and that perform mathematical processes on the input data 122 so that the input data 122 may be classified. The hidden layers 128 may include one or more convolutional layers 124A-124D, and one or more pooling layers 126A-126D. In some embodiments, each convolutional layer 124A-124D comprises one or more trainable filters or kernels that are applied to the data. Each convolutional layer 124A-124D convolves the input by a filter and passes the result to a next layer. The convolutional layers 124A-124D abstract image data to a feature map, or an activation map.

Pooling layers 126A-126D may be used after convolutional layers 124A-124D to reduce the dimensions of a feature map or other data by combining the outputs of neuron clusters at a layer into a single layer of a following layer. Thus, a pooling layer 126A-126D may combine small clusters of data to reduce the size of data before providing the reduced feature map to a next convolution layer 124A-124D. In some embodiments, pooling may be max pooling, where the maximum value in a local cluster may be provided as a neuron value to the next convolutional layer. In other embodiments, pooling may use average pooling by averaging the values of data in a particular cluster, and passing the average value as a neuron value to a next convolutional layer. The output from the hidden layers 128 may then be passed for classification to a classification element 130 such as an output layer, or the like. Additionally, on some embodiments, a classifier may be provided to classify data from each convolutional layer 124A-124D. The neuron-level classifiers may use copies of data output by the convolutional layers 124A-124D to avoid the classification interfering with data processing or training. Thus, the efficiency or accuracy of each convolutional layer 124A-124D may be evaluated during training to determine whether additional convolutional layers 124A-124D are needed, to determine whether a particular convolutional layer 124A-124D needed to be omitted from the training system or from the AI model 100, to evaluate the overall efficacy of the training process, or the like.

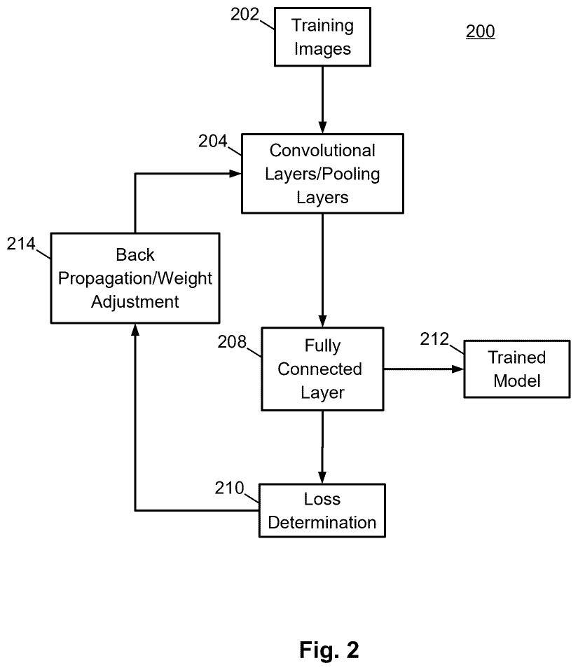

FIG. 2 is a system diagram illustrating a system 200 for training an AI agent according to some embodiments. An AI model of an AI agent uses a set of weights and biases used to make predictions, and the error for those predictions is calculated. For image recognition systems, the predictions may be predictions of whether an image is part of an identified class. A training data set having one or more training images 202 is identified. The training data set provides data that can be used to train an AI model to identify, or avoid, certain types of data, and relate that data to specified categories of classifications. For example, when training an image recognition AI agent, the training images 202 may be static images, videos, or the like, and may have data that can be positively identified as belonging to a desired classification, and data that may be positively identified as not belonging to a desired classification. The desired classification may be a category of conceptual items that the AI agent should identify an analyzed image as belonging to, or not belonging to. For example, where the desired classification is a dog, the training images may be of dogs and other items, and the AI agent may be trained to identify dog images from the training data set as belonging to the dog classification, and to identify non-dog images from the training data set as not belonging to the dog classification.

The training images 202 may be preprocessed by an input layer (not shown) to prepare the training images 202 for filtering through one or more hidden layers such as convolution layers and pooling layers 204. The convolution layers 204 may have filters with adjustable weights or biases that affect the weight given to the respective filter when processing data. The training images 202 may be processed through the convolution layers and pooling layers 204, and the resulting data is output to one or more fully connected layers 208.

The fully connected layers 208 may use, for example, a classifier to provide classification for each image from the training images. In some embodiments, the fully connected layers 208 generate probabilities that each image belongs to a particular classification. In some embodiments, a Softmax function is applied to data output from the convolutional layers and pooling layers 204. Softmax is an activation function that scales numbers or unnormalized final scores (logits) into probabilities. In some embodiments, a threshold may be applied to the probabilities or other output generated by the fully connected layers 208 to determine whether the image affirmatively meets the classification criteria. For example, the system may have a classifier that uses a 90% threshold for classification, and a training image 202 that has a greater than 90% chance of belonging to a particular class is affirmatively classified as being in the class. Alternatively, a training image that has an 20% change of belonging to a particular class may be classified as being outside the class. In some embodiments, the system may use a lower threshold when classifying training images 202 as being outside the class, with probabilities falling between the threshold resulting in the training image being undefined or unknown with respect to the class. Therefore, the system may have a lower threshold of 10%, and a training image 202 identified as having a 10% chance of being in the class may be identified as affirmatively being outside of the class, while a 25% chance of the training image 202 being in the class may result in an undefined or unknown classification for the training image 202. In other embodiments, the system may use multiple categories in a classifier, with the classifier attempting to put each image into a category. For example, a classifier may be used to classify dog images into different dog breeds with each dog breed being represented as a different class. Alternatively, for a vehicle object recognition system, a classifier may use different classes such as road obstacles separated into different classes such as pedestrians, fixed objects, vehicles, animals, traffic control devices, and the like.

In some embodiments, fully connected layers are feed forward neural networks. The fully connected layers 208 are densely connected, meaning that every neuron in the output is connected to every input neuron. In a fully connected layer 208, every output neuron is connected to every input neuron through a different weight. This is contrast to a convolution layer where the neurons are not densely connected but are connected only to neighboring neurons within a width of a convolutional kernel or filter. However, in a convolutional layer, the weights are shared among different neurons, which enables convolutional layers to be used with a large number of neurons.

The input to the fully connected layers 208 is the output from the final convolutional layer or final pooling layer 204, which is flattened and then fed into the fully connected layers 208. During training of an AI agent, outputs from the fully connected layers 208 are passed to a loss determination element 210 that evaluates the results of the AI agent processing and provides data used to adjust weights and biases of the convolutional layers by back propagation or weight adjustment 214.

The loss determination element 210 specifies how training penalizes the deviation between the predicted output of the network, and the true or correct data classification. Various loss functions can be used, depending on the specific task. In some embodiments, the loss determination element 210 applies a loss function that estimates the error of a set of weights in convolution layers of a neural network. For example, errors in an output may be measured using cross-entropy. For example, in some training systems, the likelihood of any particular image belonging to a particular class is 1 or 0, as the class of the images is known. Cross entropy is the difference between an AI agent predicted probability distribution given the dataset and the distribution of probabilities in the training dataset. The loss determination element 210 may use a cross entropy analysis to determine loss for a training image 202 or set of training images 202.

Back propagation allows application of the total loss determined by the loss determination element 210 back into the neural network to indicate how much of the loss every node is responsible for, and subsequent updating of the weights in a way that minimizes the loss by giving the nodes with higher error rates lower weights, and vice versa. For example, in some embodiments, a loss gradient may be calculated, and used, via back propagation 214, for adjustment of the weights and biases in the convolution layers. A gradient descent algorithm may be used to change the weights so that the next evaluation of a training image 202 reduces the error identified by the loss determination element 210, and where the optimization algorithm navigates down the gradient (or slope) of error. Once the training images 202 are exhausted, or the loss of the model falls below a particular threshold, the AI agent may be saved, and used as a trained model 212.

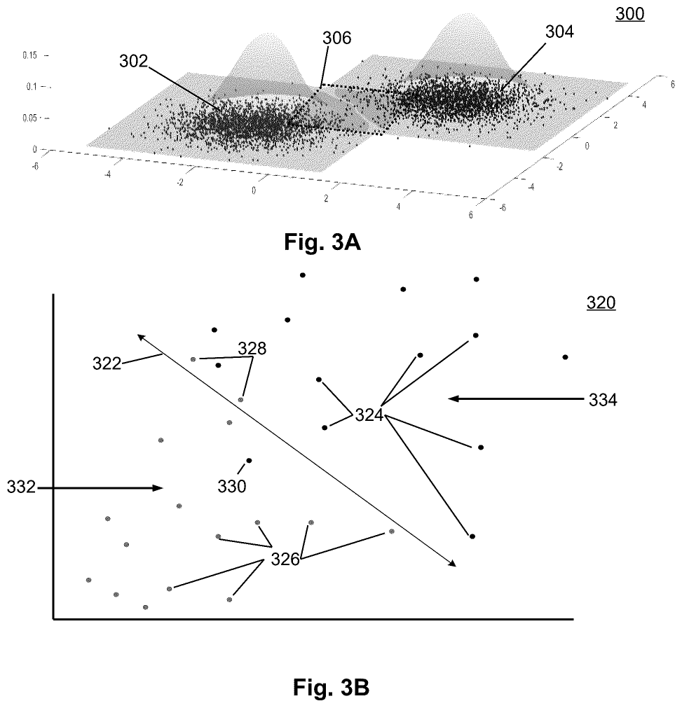

FIGS. 3A-3B are diagrams illustrating data distributions according to some embodiments. FIG. 3A is a diagram illustrating a chart 300 with surfaces representing data distributions in a three-dimensional format according to some embodiments. FIG. 3B is a diagram illustrating a chart 320 showing data distributions of data in different categories 332, 334 and a separation plane 322 generated by a classifier according to some embodiments.

FIG. 3A illustrates a data distribution for two exclusive categories 302, 304 of data. The z-axis may represent the density of a data distribution, while the x-axis and y-axis are used to measure special representations related to the data itself. Data presented to an AI agent for analysis using an NN with a classifier may include data points that fall into multiple categories 302, 304, and the categories may have an overlap region or interface region 306 where data points may not conclusively be identifiable as belonging to a first category 302 or a second category 304. For example, data points of the first category 302 represent cancer analysis data, where healthy cell populations, and data points of the second category 304 represent cancerous populations. The data for cancers and health cells may be represented with, for example, as size and metabolic activity for cells on two axes, and density of a data population in a third axis.

The categories 302, 304 may have an interface region 306 where data points may not be conclusively identifiable as belonging to a first category 302 or a second category 304. Some data distributions cannot be separated, as some cancerous cells may at least partly look like healthy cells. Thus, in the example of cancerous and healthy cells, some cells in the interface region 306 may have features that indicate that the cell is both healthy and cancerous.

Neural networks attempt to classify data by defining a hyperdimensional surface of separation or separation plane 322 between the two, or more, data categories 332, 334. If there is little or no overlap in the data, then a NN can be highly performant. This is because there is little chance that data being processed by an NN will fall into the interface region 306. However, if there is a significant degree of overlap between data distributions for two or more categories 302, 304 of data then proper classification of the data can be difficult. Knowing the achievable efficiency of data classification is an important part of NN certification. Quantifying the efficiency of an NN permits analysis of the efficiency, or accuracy, of the quantifier, and permits identification of non-desirable classifiers. Additionally, quantifying the efficiency or accuracy of a classifier permits regulation, validation, verification and other performance analyses to verify and track the safety of a particular classifier, NN, or AI agent.

For example, as shown in FIG. 3B, data points that are output by a classifier may be associated with different evaluations of features that may be associated with different categories or characteristics of different categories. The axes in FIG. 3B are spatial, without units. A classifier analyzes each data point and returns an answer and a confidence in the answer, and the answers and confidences output to the classifier may be modelled using Gaussian distribution.

A first characteristic may be rated on, for example, a scale of the lateral or x-axis of the chart 320, and a second characteristic may be rated in, for example, the vertical, or y-axis, of the chart 320. In some embodiments, the x-axis may represent assignment of values for classification by a NN detection layer or convolutional layer, while the y-axis may be associated with higher layer agent detection, such as assignment by a higher AI agent layer, of the likelihood that an output falls within a particular classification. The characteristics may be used to define whether a data point falls within a first category 332 or a second category 334.

In some embodiments, the accuracy of the AI classifier may be evaluated during training at the neuron level to determine whether a particular level of neurons sufficiently condenses data. In-training accuracy evaluation may be used to determine whether additional levels of neurons are needed to avoid too much data output falling within a category margin. This permits design and engineering at the neuron level. The training data may be data where a classification is known before processing, and the output at a particular neuron level may be evaluated as a particular piece of training data is processed.

In some embodiments, after an AI agent is trained, validation data may be processed through the AI agent, and the output may be used to determine the accuracy of the AI agent or classifier. The validation data may be data where the characteristics or category is known before processing, and the known classifications may be compared to the output of the AI agent to determine whether the AI agent classification of the validation data was correct. Information being pushed back during validation indicates correct performance of the network as a whole.

A region of possible data values shown in the chart 320 may, for example, have two different possible categories 332, 334, with a first category 332 separated from a second category 335 by a separation plane 322. First data points 326 may be correctly categorized outputs that were categorized as belonging to the first category 332. Second data points 324 may be correctly categorized outputs that were categorized as belonging to the second category 334. First miscategorized data points 328 may be outputs that actually belong to the first category, but that were categorized as belonging to the second category 334. Thus, the first miscategorized datapoints 328 may be false positives for the second category 334, and false negatives for the first category 332. Similarly. second miscategorized data points 330 may be outputs that actually belong to the second category 334, but that were categorized as belonging to the first category 332. This analysis effectively defines true positives, true negatives, false positives and false negatives, and permits analysis of when an AI agent fails, and may indicate why a failure occurs.

The system and methods described herein are embodiments or principles for quantifying the accuracy of these correct and miscategorized data points. Analysis of how close data values are to the separation plane 322 permits quantification of how polluted the region near the separation plane 322 is for a particular NN or AI agent. Ideally, data will be spaced apart from the separation plane 322, and in the correct category 332, 334, so that there is no region of overlap in the categories 332, 334 resulting from classification. Quantifying the room between populations of different categories 332, 334 indicates how strong the classifier is. A large distance indicates a strong classifier, and that nothing has been misclassified.

Additionally, the data output of individual neurons may be analyzed to determine the strength of a particular neuron in an NN or AI agent. For example, each trained neuron may be analyzed to get a probability density function for the neuron to determine how accurate that particular neuron is. Thus, training and validation may be performed on a neural network, and then, in a validation stage, statistics may be pushed back through the neurons of the NN without updating the neurons, to permit gathering or updating of statistics about a particular neuron. A particular neuron that is determined to be low-performing may then be excluded from the NN, may have weights adjusted, may be refitted with a new or adjusted model, or otherwise changed, or adjusted to improve the neuron performance, and the overall performance of the NN. For example, during validation, every time n NN gets a false positive, the results or validation data may be pushed back through each neuron, and the output for that neuron may be checked.

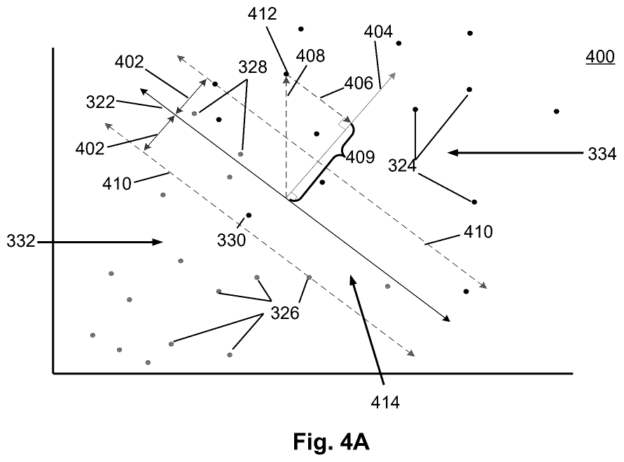

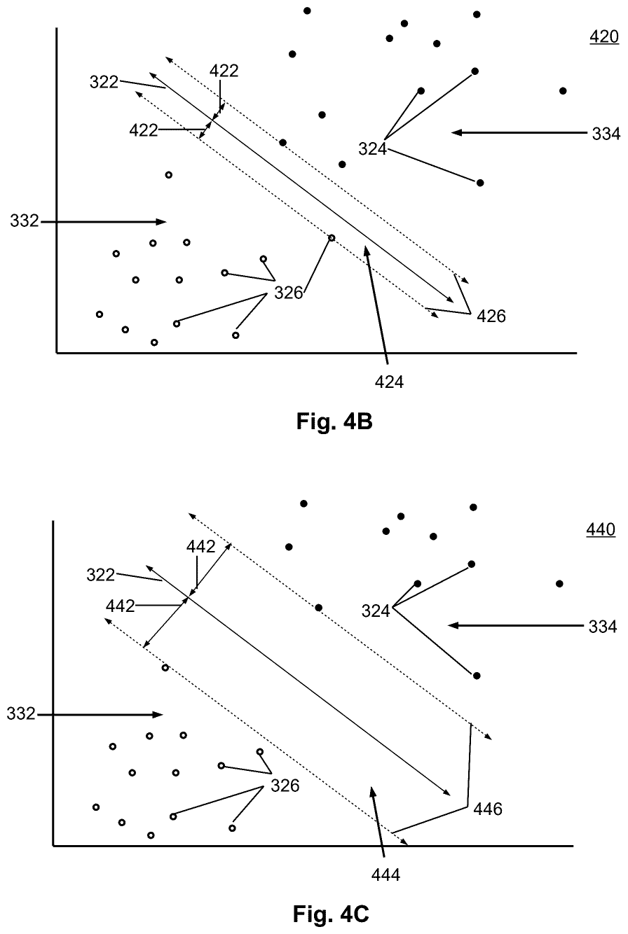

FIGS. 4A-4C are diagrams illustrating evaluation of outputs for individual neurons according to some embodiments. In particular, FIG. 4A is a diagram illustrating a chart 400 of categorized outputs and evaluation of a neuron accuracy according to some embodiments. A system may determine a confidence metric 409 for a particular data point or target output 412, and may use one or more confidence metrics 409 to determine the accuracy of a neuron layer, neuron, neural network, portion of a neural network, classifier, or the like. The chart 400 illustrates a method for extracting information with respect to the ability of a neuron or neural network element to classify information. This performance information is returned to either a user or subsequent classification agents to enable the assessment of the utility of the neuron or initial classifier. Such performance metrics are particularly useful for neural networks because they enable more accurate training and more insightful design of neural network architectures, and for adjusting performance of a neural network at the neuron level. The method may be applied to individual neurons, the kernel layer of a neural network, to a classifier used after training of a neural network, or to another neural network element. The method uses support vectors 410 to define data set overlap or confidence, but does not directly affect training. Thus, the system may be considered a support vector machine, and the method may provide for eliciting low level performance metrics about kernel level classifiers within an NN. For neural networks, a support vector machine may be trained to measure the efficiency of classification. These low-level metrics measure the overlap between the two data sets being classified, and are therefore an indicator of the achievable performance for the neuron, classifier or NN element, when, how, and why a classifier will incorrectly classify data, and whether a classifier should or should not be used as part of an AI/ML agent.

The support vectors 410 could be curves, planes, hyperplanes or other shapes, and in some embodiments, may have multiple dimensions. Support vectors may be on opposing sides of the separation plane 322, however, imbalances in distances between support vectors 410 and the separation plane 410 are not critical, as the shortest distance between the separation plane 322 and a support vector 410 controls the accuracy of the overall system, neuron, or NN element. The separation plane 322 may be moved to balances distances between the support vectors. However, an imbalance in false positives or incorrect data classifications may be informative. The distribution might inform on the nature of an agent or of a particular neuron, and inform on the ability to classify information.

In some embodiments where data points from different output categories 332, 334 overlap each other, a category 332, 334 may be where true positives for the relevant category 332, 334 are separate from the false positives. The region between clearly definable categories 332, 334 correlates to support vectors 410 for a particular set of results or outputs.

A plane of separation 322 may be a hyperplane used as a classifier and that is defined between two categories 332, 334 of data outputs. The plane of separation 322 may be a linear vector in data space defined using formula (1.1):

$$x = α d + o \qquad ( 1.1 )$$

Alternatively, the plane of separation 322 may be a plane defined by formula (1.2):

$$g ( ω \cdot i ) \qquad ( 1.2 )$$

where the function g( ) is an activation function, and w·i represents the plane (or surface) of separation. The dot product w·i related to the surface of separation in dimensional space as shown in formula 1.3:

$$n \cdot ( x - {x}_{0} ) = 0 = w \cdot i \qquad ( 1.3 )$$

where i is the input vector to the current layer, x₀ is a reference point that lies on the surface of separation, and w is the weights applied to the input values for the current layer.

In some embodiments, determining where output data point is in with respect to the plane of separation 322 may use a dot product of weights and an input layer, as shown in formula (2):

$$D = ω \cdot i \qquad ( 2 )$$

In formula (2), w is an equation for the hyperplane, and defines operation of the geometric system. The output D of formula (2) is sometimes interpreted as the distance from the plane of separation 322, and the sign (for example) shows which side of the plane of separation 322 or side of classifier line 332/334 fall on. Each neuron may have its own weight, so all the weights of all the neurons affect the results. Thus, to analyze a specific neuron, a specific weight may be determined for a specific neuron, as low level information is lost after a neuron provides an output. Therefore, weights for a neuron may be determined from training.

Determination of the confidence of outputs may not use formula 2, because the dot products only occur at the neuron level. Additionally, calculation of confidence level or metrics may require further processing to get a single output, such as translation, for example.

To quantify the level of correctness, or the confidence in the ability of a neuron, classifier or other neural network element to differentiate which category an input should be classified in, the spacing or distance of output values from the support vectors 410 may be calculated as a confidence metric 409 for each output. The support vectors 410 indicate how much overlap is between different categories 332, 334, or how much room or margin is between the categories 332, 334. The support vectors 410 may, in some embodiments, be based off nearest good point beyond farthest bad point.

A confidence metric 409 for a target output 412 may be a distance r along a normal vector between an intersection of the normal vector 404 and the separation plane 322. The normal vector 404 may be in the n direction and normal or perpendicular to the plane of separation 322, where n is perpendicular to the separation plane 322, such that formula (3) is true:

$$n : n \cdot d = 0 \qquad ( 3 )$$

The confidence metric 409 r may be the distance along the projection 404, from the separation plane 322 and may indicate a likelihood that a classification data point is misclassified or is classified in an incorrect class. The position of the target output 412 is used to determine a position vector 408 from the intersection of the normal vector 404, with the confidence metric 409 being the projection of the position vector onto the normal vector 409 at the vector 406 that is orthogonal to n. The sum or totality of the confidence metrics 409 of all data points may indicate an overall performance or confidence level for the neuron, classifier, or neural network element. The distance from the separation plane 322 and confidence metric vector 409 r may be defined by formula (4):

$${proj}_{n} v \qquad ( 4 )$$

where v is 412 and n is normalized.

Support vectors 410 may be defined according to the separation plane 322, and may be parallel to the separation plane 322, and fall on each side of the separation plane 322 by margin 402 M to define a region of uncertainty or the interface region 414. In some embodiments, the support vectors 410 may be defined as a line between, or at, a last good value after a last miscategorized value. For example, in FIG. 4A, the second miscategorized data point 330 is a last bad, or miscategorized data point, or a datapoint on a wrong or incorrect side of the separation plane 332, and that is farthest away from the separation plane 322 on the wrong side or in the wrong category. The first data point 326 may be on the support vector 410 and be the next good value, or correctly categorized value closest to the plane of separation on the right side, or in the correct category. Thus, confidence metrics for all false positives or incorrect values may be determined, and the largest false value confidence metric is identified. The confidences for all true values, or correctly categorized output values are calculated, and any true value confidences less than the largest false value are removed from consideration. The remaining smallest true value confidence metric is the next good value, and the support vector 410 for a particular side may be associated with the identified remaining smallest true value confidence metric. The same is done for both sides of the separation plane 322 to locate both support vectors 410.

If v is the closest correctly classified value to the hyperplane of separation h beyond the second miscategorized data point 330, and lies in the two-dimensional plane shown in FIG. 3B or FIG. 4A, then the support vectors 410 may be defined in 2 dimensional space (2D) by formulas (5) and (6):

$${x}^{′} = α d + o - ( {proj}_{n} v ) n \qquad ( 5 )$$

$${x}^{″} = α d + o + ( {proj}_{n} v ) n \qquad ( 6 )$$

For the generalized case, the equation for the hyperplane of separation is:

$$\{ x ∈ h \vert n \cdot ( x - {x}_{0} ) = 0 \} \qquad ( 7 )$$

The metric M can be defined as:

$$‖ v - {proj}_{h} v ‖ \qquad ( 8 )$$

where v is the closest correctly classified value to h beyond the farthest misclassified value from h, and where the [symbol] k support vectors can be defined as

$${x}^{′} = h + ‖ v - {proj}_{h} v ‖ n \qquad ( 9 )$$

$${x}^{″} = h - ‖ v - {proj}_{h} v ‖ n \qquad ( 10 )$$

The region between the first support vector 410 x′ and the second support vector 410 x″ is the interface region 414 between classification categories 332, 334. When the interface region 414 has misclassified data points, the interface region 414 may be an overlap region, with the different categories 332, 334 overlapping. This may indicate that the neuron, classifier, or NN element provides a soft margin for classification.

Outputs that fall within this interface region 414 will have a low confidence metric, and are more likely than outputs outside of that region to be miscategorized. In some embodiments, the support vectors may be selected to cover a region according to a desired confidence level threshold, so that any data points that fall within the overall region are below a confidence level threshold, and any data points that fall outside the interface region 414 are above the confidence level threshold. Thus, the interface region 414 may, in some embodiments, define a threshold for a confidence metric 409 r being considered sufficient. Additionally, outputs with confidence metrics 409 r that put the output in the interface region 414 would be considered too low to be reliable.

In some embodiments, a system may determine a number of outputs that fall in the interface region 414 compared to the number of outputs outside of the interface region 414. If the number or percentage of outputs within the interface region exceeds a threshold, the confidence in the overall classifier may be low, and the classifier may be identified for adjustment or replacement. Thus, if too many outputs are unreliable, the classifier itself may be considered unrelatable and adjusted.

In contrast, where the categories 332, 334 are well separated, with a neuron, classifier or other NN element able to identify data points for different categories 332, 334, with a high level of accuracy or confidence, the neuron, classifier or other NN element is highly performant. This may include outputs with no misclassified data on each side of the separation plane 322, and with no data outputs between the support vectors 410. In such an instance, the neuron, classifier, or NN element provides a hard or firm margin for classification. The margins 402 may indicate the strength of quality of the neuron, classifier of NN element.

In some embodiments, the support vectors 410 may be pushed or moved so that there are no data points within the margins or the interface region 414.

FIG. 4B is a diagram illustrating a chart 420 of categorized outputs with hard margins 422 according to some embodiments. In some embodiments where first data points 326 are correctly classified as belonging to a first category 332 and second data points 324 are correctly classified as belonging to a second category 334, the first data points 326 or second data points 424 may be relatively close to the separation plane 322. The support vectors 426 may be moved to exclude all of the data points, resulting in relatively small margins 422, even though the margins 422 are hard margins, and the neuron, classifier or NN element has correctly classified each data point.

FIG. 4C is a diagram illustrating a chart 440 of categorized outputs with hard margins 422 according to some embodiments. The first data points 326 may be correctly classified as belonging to a first category 332 and second data points 324 correctly classified as belonging to a second category 334. However, in contrast to FIG. 4B, the first data points 326 or second data points 424 may be farther from the separation plane 322, and the support vectors 446 may be farther from the separation plane 322 while still excluding all of the data points, resulting in relatively larger margins 442.

Thus, in some embodiments, the margins and data distributions output by a classifier, neuron or NN element may be used to evaluate the performance of that feature. For example, a data distribution may be analyzed for a classifier to determine whether the data distribution is sufficient to guarantee performance, or whether other classifiers may be needed to provide the required or desired performance. Additionally, a margin for each neuron may be analyzed, for example, during training, to determine whether a particular neuron needs to be removed, adjusted replaced, or the like.

In some embodiments, a system may be used to determine if a result from an NN or AI agent result is in a margin region, and that result may be discarded, or treated with low confidence. Multiple classifiers may be used to handle the same task, for example, by using different data sets, looking at the same data set differently, using different training set or different neuron or NN models, or the like. Therefore, if one NN or AI agent is particularly performant at one particular classification, and less performant at others, and other NN or AI agents work in other data spaces, then a set of neurons that are generally performant may be designed to take data from, or listen to, the highly performant NN or AI agent for the particular classification, but may be excluded for other classifications or data sets. Thus, an NN or AI agent may be employed in general use, in limited scope, or excluded completely. Each NN or AI agent may be certified as working in a certain regime or with a certain operating parameter, with the certification being based on the size of a hard margin, or based on a soft margin with exclusions, requirements for other, supplemental agents, or the like. For example, for a vision sensor used in a rotorcraft autonomous landing system, a particular NN or AI agent may be rated as highly reliable during normal conditions, but for blackout conditions, may be related as unreliable, with many data points for low light or no light conditions failing within the interface region and having a low confidence metric or being misclassified. Thus, a monitoring system may detect the blackout condition, and the NN or AI agent may be shut off or substituted with a different NN or AI agent.

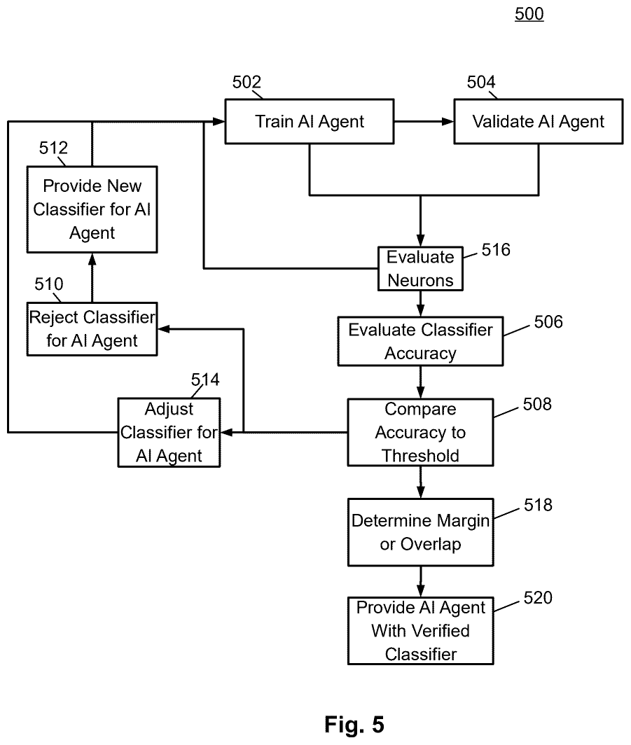

FIG. 5 is a flow diagram illustrating a method 500 for evaluating a classifier for inclusion in an AI agent according to some embodiments. In some embodiments, the method 500 may be performed by a system that runs on one or more computer platforms to automate the training, validation and evaluation process for a classifier. For example, the system may have one or more processors or circuits that are configured to perform the method 500. In some embodiments, the processor being configured to perform the method 500 may include the system having one or more computer readable mediums storing computer programs for at least evaluating classifier outputs, with the computer program including instructions for performing the method 500. In some embodiments, the circuits are application specific integrated circuits (ASICs), field programmable gate array (FPGA), or the like, and have circuitry set to perform the method. Additionally, a combination of software and hardware may be used, for example, with software controlling operation of the circuits to manage training or validation and AI agent or evaluation of classifiers. For example, dedicated ASICs may be used for training AI models to take advantage of the high speeds and high data throughput afforded by dedicated ASICs, with a software system controlling operation of the ASICs by providing training data, to the ASICs, and for evaluating the outputs of classifiers during the AI agent training. In other embodiments, the AI agent training and validation, and classifier evaluation may be performed, at least partially, on a distributed system such as a cloud computing system. For example, AI training or validation may be performed across multiple instances on a cloud platform to take advantage of the scalability provided by a cloud platform.

Performing the method 500 may include, in block 502, an AI agent being trained according to some embodiments. In block 504, an AI agent may be validated. The training or validating the AI agent may include, in some embodiments, causing, by providing data to an AI agent having an NN, processing of the data by a plurality of convolutional layers in the NN of the AI agent. Training or validating the AI agent may include processing data though an AI model, and may, in some embodiments, include using a classifier to classify output from at least one convolutional layer or neural layer during the training or validation so that the classifier classifies processed training data from a neural layer before the data is completely processed through the AI agent. Additionally, in some embodiments, training or validation of the AI agent may include, in block 516, analyzing data outputs at the neuron level to determine a margin or level of category overlap for an individual neuron, and adjustment or removal of neurons based on testing of a neuron during the training or validation.

Thus, the training or validation may include classifying data from a first neural layer within a stack or set of neural layers, and the first neural layer may be a layer other than the final or last neural layer in the set of neural layers. In some embodiments, the one or more outputs are generated during training of the AI agent. In other embodiments, the one or more outputs are generated during validation of the AI agent. In some embodiments, a convolutional layer being evaluated is a layer in a plurality of convolutional layers before a final convolutional layer.

In some embodiments, the method may include, in block 506, evaluating the accuracy of a classifier of a NN of an artificial intelligence agent. In some embodiments, evaluating the classifier accuracy may include generating one or more classification data points by processing the one or more outputs through a classifier of the NN that classifies the one or more outputs into two or more classifications. An interface region between the two or more classifications may be determined, and a percentage of classification data points that fall into the interface region may then be determined, or a margin, and the magnitude of the margin may be determined.

In some embodiments, determining the interface region comprises determining a separation plane between the two or more classifications, and determining support vectors according to the separation plane, data outputs, or the like, such that the interface region is defined by the support vectors. A system that has classification data points that fall with the interface region may be identified as having a soft margin with classification data points in an overlap region. Additionally, a system that has an identifiable region between classifications or categories may have a hard margin, with the magnitude of the margin related to a distance at which support vectors may be placed with no data points between the support vectors or in the interface region.

The percentage of classification data points that fall into the interface region may be associated with the accuracy, reliability, or confidence level of the classifier. In some embodiments, determining the relationship between the data points and the separation plane comprises determining a confidence metric for each of the classification data points, and determining whether each of the classification data points falls within the interface region according to a value of the respective classification data point, the confidence metric for the respective classification data point, and the support vectors or interface region. Thus, the confidence metric may be used to determine whether the classification data point is within the interface region. In some embodiments, determining the confidence metric for each of the classification data points includes determining the confidence metric for each of the classification data points according to a distance of the respective classification data point projected to a projection perpendicular to the separation plane. Additionally, the confidence metric for each of the classification data points may be associated with a likelihood that the respective classification data point is misclassified.

In block 508, the accuracy of the classifier may be compared to a threshold. In block 518, the margin or overlap for a classifier may be determined. The margin or overlap may be related to the confidence metric for data points processed by an AI agent during training or validation. In some embodiments, the overlap between categories may include mischaracterized data points, or data points that are characterized correctly, but have a low confidence metric, and that fall within the interface region or between the support vectors. In such an instance, a second AI agent may be identified for data space that would fall within the interface region for the initial AI agent, the initial AI agent may be identified as not handling data falling within the interface region, or the use or implementation of the initial AI agent or classifier may be limited or otherwise modified for identified data spaces. Thus, an AI agent or classifier may be certified for certain data spaces, and limited in noncertified data spaces, or when handling data that may result, or that does result, in the AI agent output being unreliable. In some embodiments where there is no overlap between data categories, and a hard margin is identified for an initial AI agent, the margin may be quantified to permit different AI agents to be compared for particular data spaces, and the level of confidence in the overall AI agent or classifier may be identified and the AI agent certified based on the overall confidence level in the AI agent.

In block 520, the AI agent may be provided as an AI agent with a verified classifier in response to the percentage of classification data points that fall outside the interface region being above the threshold, in response to the margins being above a predetermined threshold, or according to another metric or criterion. Thus, an AI agent with a verified classifier may have a classifier that processes outputs having a percentage of classification data points that fall within the interface region being below the threshold.

In some embodiments, the classifier may be identified for modification in response to the percentage of classification data points that fall into the interface region being above the threshold. Thus, where the classifier is deemed to be unreliable due to too much data falling into the interface region, the classifier may be modified by changing the classifier, by adjusting the classifier, or by being replaced. Thus, in block 514, the classifier may be adjusted for the AI agent. Modifying the classifier may include modifying thresholds or characteristics used to determine the classifications, by changing weights used for classification, or the like. In block 510, the classifier may be rejected for the AI agent, and in block 512, a new classifier may be provided for the AI agent, and the new AI trained and validated.

An embodiment system includes at least one processor, and at least one first non-transitory computer readable medium having computer program code stored thereon for execution by the at least one processor to evaluate a classifier of a neural network (NN) of an artificial intelligence (AI) agent. The computer program code includes instructions for causing, by providing data to the AI agent, processing of the data by a plurality of convolutional layers in the NN of the AI agent, receiving one or more outputs from a first convolutional layer of the plurality of convolutional layers, generating one or more classification data points by processing the one or more outputs through a classifier that classifies the one or more outputs into two or more classifications, determining an interface region between the two or more classifications, determining a percentage of classification data points that fall into the interface region, and providing the AI agent as an AI agent with a verified classifier in response to the percentage of classification data points that fall into the interface region being below a threshold.

In some embodiments, the first convolutional layer is a layer in the plurality of convolutional layers before a final convolutional layer. In some embodiments, the one or more outputs are generated during training of the AI agent. In some embodiments, the computer program code further includes instructions for identifying the classifier for modification in response to the percentage of classification data points that fall into the interface region being above the threshold. In some embodiments, the instructions for determining the interface region include instructions for determining a separation plane between the two or more classifications, and determining support vectors according to the separation plane, where the interface region is defined by the support vectors. In some embodiments, the instructions for determining the percentage of the classification data points that fall into the interface region include instructions for determining a confidence metric for each of the classification data points, and determining whether each of the classification data points falls within the interface region according to a value of the respective classification data point and further according to the confidence metric for the respective classification data point. In some embodiments, the instructions for determining the confidence metric for each of the classification data points include instructions for determining the confidence metric for each of the classification data points according to a perpendicular distance of the respective classification data point projected to a projection perpendicular to the separation plane. In some embodiments, the confidence metric for each of the classification data points is associated with a likelihood that the respective classification data point is misclassified.

An embodiment method includes causing, processing of the data by a plurality of convolutional layers in a neural network (NN) of an artificial intelligence (AI) agent, where the processing of the data is caused providing data to the AI agent, receiving one or more outputs from a first convolutional layer of the plurality of convolutional layers, generating one or more classification data points by processing the one or more outputs through a classifier of the NN that classifies the one or more outputs into two or more classifications, determining an interface region between the two or more classifications, determining a percentage of classification data points that fall into the interface region, and providing the AI agent as an AI agent with a verified classifier in response to the percentage of classification data points that fall into the interface region being below a threshold.

In some embodiments, the first convolutional layer is a layer in the plurality of convolutional layers before a final convolutional layer. In some embodiments, the one or more outputs are generated during training of the AI agent. In some embodiments, the method further includes identifying the classifier for modification in response to the percentage of classification data points that fall into the interface region being above the threshold. In some embodiments, the determining the interface region includes determining a separation plane between the two or more classifications, and determining support vectors according to the separation plane, where the interface region is defined by the support vectors. In some embodiments, determining the percentage of the classification data points that fall into the interface region includes determining a confidence metric for each of the classification data points, and determining whether each of the classification data points falls within the interface region according to a value of the respective classification data point and further according to the confidence metric for the respective classification data point. In some embodiments, the determining the confidence metric for each of the classification data points includes determining the confidence metric for each of the classification data points according to a perpendicular distance of the respective classification data point projected to a projection perpendicular to the separation plane. In some embodiments, the confidence metric for each of the classification data points is associated with a likelihood that the respective classification data point is misclassified.

An embodiment system includes at least one processing circuit, configured to evaluate a classifier of a neural network (NN) of an artificial intelligence (AI) agent, where the at least one processing circuit is configured to perform receiving one or more classification data points associated with one or more outputs that are processed through a classifier and that are outputs associated with data processing by a first convolutional layer of a plurality of convolutional layers of the NN, where the one or more classification data points are associated with two or more classifications performed by the classifier, determining a separation plane between the two or more classifications, determining support vectors according to the separation plane, where an interface region is defined by the support vectors, determining a percentage of classification data points that fall into the interface region, and providing the AI agent as an AI agent with a verified classifier in response to the percentage of classification data points that fall into the interface region being below a threshold.

In some embodiments, the at least one processing circuit being configured for determining the percentage of the classification data points that fall into the interface region includes the at least one processing circuit being configured for determining a confidence metric for each of the classification data points, and determining whether each of the classification data points falls within the interface region according to a value of the respective classification data point and further according to the confidence metric for the respective classification data point. In some embodiments, the at least one processing circuit being configured to perform determining the confidence metric for each of the classification data points includes the at least one processing circuit being configured to perform determining the confidence metric for each of the classification data points according to a perpendicular distance of the respective classification data point projected to a projection perpendicular to the separation plane. In some embodiments, the confidence metric for each of the classification data points is associated with a likelihood that the respective classification data point is misclassified.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system, comprising:
at least one processor; and
at least one first non-transitory computer readable medium having computer program code stored thereon for execution by the at least one processor to evaluate a classifier of a neural network (NN) of an artificial intelligence (AI) agent, the computer program code including instructions for:
causing, by providing data to the AI agent, processing of the data by a plurality of convolutional layers in the NN of the AI agent;
receiving one or more outputs from a first convolutional layer of the plurality of convolutional layers;
generating one or more classification data points by processing the one or more outputs through a classifier that classifies the one or more outputs into two or more classifications;
determining an interface region between the two or more classifications;
determining a percentage of classification data points that fall into the interface region; and
providing the AI agent as an AI agent with a verified classifier in response to the percentage of classification data points that fall into the interface region being below a threshold.

2. The system of claim 1, wherein the first convolutional layer is a layer in the plurality of convolutional layers before a final convolutional layer.

3. The system of claim 2, wherein the one or more outputs are generated during training of the AI agent.

4. The system of claim 1, wherein the computer program code further includes instructions for:
identifying the classifier for modification in response to the percentage of classification data points that fall into the interface region being above the threshold.

5. The system of claim 1, wherein the instructions for determining the interface region include instructions for:
determining a separation plane between the two or more classifications; and
determining support vectors according to the separation plane, wherein the interface region is defined by the support vectors.

6. The system of claim 5, wherein the instructions for determining the percentage of the classification data points that fall into the interface region include instructions for:
determining a confidence metric for each of the classification data points; and
determining whether each of the classification data points falls within the interface region according to a value of the respective classification data point and further according to the confidence metric for the respective classification data point.

7. The system of claim 6, wherein the instructions for determining the confidence metric for each of the classification data points include instructions for:
determining the confidence metric for each of the classification data points according to a perpendicular distance of the respective classification data point projected to a projection perpendicular to the separation plane.

8. The system of claim 6, wherein the confidence metric for each of the classification data points is associated with a likelihood that the respective classification data point is misclassified.

9. A method, comprising:
causing processing of data by a plurality of convolutional layers in a neural network (NN) of an artificial intelligence (AI) agent, wherein the processing of the data is caused by providing the data to the AI agent;
receiving one or more outputs from a first convolutional layer of the plurality of convolutional layers;
generating one or more classification data points by processing the one or more outputs through a classifier of the NN that classifies the one or more outputs into two or more classifications;
determining an interface region between the two or more classifications;
determining a percentage of classification data points that fall into the interface region; and
providing the AI agent as an AI agent with a verified classifier in response to the percentage of classification data points that fall into the interface region being below a threshold.

10. The method of claim 9, wherein the first convolutional layer is a layer in the plurality of convolutional layers before a final convolutional layer.

11. The method of claim 10, wherein the one or more outputs are generated during training of the AI agent.

12. The method of claim 9, further comprising:
identifying the classifier for modification in response to the percentage of classification data points that fall into the interface region being above the threshold.

13. The method of claim 9, wherein the determining the interface region comprises:
determining a separation plane between the two or more classifications; and
determining support vectors according to the separation plane, wherein the interface region is defined by the support vectors.

14. The method of claim 13, wherein determining the percentage of the classification data points that fall into the interface region comprises:
determining a confidence metric for each of the classification data points; and
determining whether each of the classification data points falls within the interface region according to a value of the respective classification data point and further according to the confidence metric for the respective classification data point.

15. The method of claim 14, wherein the determining the confidence metric for each of the classification data points includes:
determining the confidence metric for each of the classification data points according to a perpendicular distance of the respective classification data point projected to a projection perpendicular to the separation plane.

16. The method of claim 14, wherein the confidence metric for each of the classification data points is associated with a likelihood that the respective classification data point is misclassified.

17. A system, comprising:
at least one processing circuit, configured to evaluate a classifier of a neural network (NN) of an artificial intelligence (AI) agent, wherein the at least one processing circuit is configured to perform:
receiving one or more classification data points associated with one or more outputs that are processed through a classifier and that are outputs associated with data processing by a first convolutional layer of a plurality of convolutional layers of the NN, wherein the one or more classification data points are associated with two or more classifications performed by the classifier;
determining a separation plane between the two or more classifications;
determining support vectors according to the separation plane, wherein an interface region is defined by the support vectors;
determining a percentage of classification data points that fall into the interface region; and
providing the AI agent as an AI agent with a verified classifier in response to the percentage of classification data points that fall into the interface region being below a threshold.

18. The system of claim 17, wherein the at least one processing circuit being configured to perform determining the percentage of the classification data points that fall into the interface region comprises the at least one processing circuit being configured to perform:
determining a confidence metric for each of the classification data points; and
determining whether each of the classification data points falls within the interface region according to a value of the respective classification data point and further according to the confidence metric for the respective classification data point.

19. The system of claim 18, wherein the at least one processing circuit being configured to perform determining the confidence metric for each of the classification data points includes the at least one processing circuit being configured to perform:
determining the confidence metric for each of the classification data points according to a perpendicular distance of the respective classification data point projected to a projection perpendicular to the separation plane.

20. The system of claim 18, wherein the confidence metric for each of the classification data points is associated with a likelihood that the respective classification data point is misclassified.
